(19) United States
(12) Patent Application Publication
(10) Pub. No.: US 2025/0122819 A1
(43) Pub. Date: Apr. 17, 2025

(54) EXHAUST DEVICE

(71) Applicant: KAWASAKI MOTORS, LTD., Hyogo (JP)

(72) Inventors: Aya NOGUCHI, Hyogo (JP); Takafumi MATSUMOTO, Hyogo (JP); Nozomu NAKAGAWA, Hyogo (JP); Shigeki YAMAMOTO, Hyogo (JP)

(73) Assignee: KAWASAKI MOTORS, LTD., Hyogo (JP)

(21) Appl. No.: 18/910,501

(22) Filed: Oct. 9, 2024

(30) Foreign Application Priority Data
Oct. 13, 2023 (JP) 2023-177560

(51) Int. Cl. F01N 3/24; F01N 13/10

(52) U.S. Cl. CPC F01N 3/24; F01N 13/008; F01N 13/009; F01N 2560/025

(57) ABSTRACT

An exhaust device includes: an exhaust chamber defining within an exhaust gas passage an expansion space in which exhaust gas is allowed to expand; a chamber inlet pipe coupled to the exhaust chamber and having a downstream end that is open to the expansion space; a first catalyst located in the exhaust gas passage upstream of the expansion space; and a second catalyst located in the chamber inlet pipe in opposition to the expansion space.

### CROSS REFERENCE TO THE RELATED APPLICATION

This application is based on and claims Convention priority to Japanese patent application No. 2023-177560, filed Oct. 13, 2023, the entire disclosure of which is herein incorporated by reference as a part of this application.

### BACKGROUND OF THE INVENTION

### Field of the Invention

The present disclosure relates to an exhaust device that forms a part of an exhaust gas passage through which exhaust gas from an engine is allowed to pass, and that purifies the gas and discharges the same to the external environment.

### Description of Related Art

Exhaust devices for an engine has been known in which two catalysts that purify exhaust gas are located spaced apart in the direction of flow of the exhaust gas (e.g., JP Laid-open Patent Publication No. 2007-046463).

Increase in the quantity of catalyst carried can bring about an improved purification performance. However, increasing the quantity of catalyst carried generally leads to more cost.

### SUMMARY OF THE INVENTION

The disclosure herein provides an exhaust device which can bring about an improved purification performance with little increase in the quantity of catalyst carried.

The present disclosure provides an exhaust device that forms an exhaust gas passage through which exhaust gas from an engine is allowed to pass, and that purifies the exhaust gas and discharges the exhaust gas to the external environment. The exhaust device includes: a casing component defining within the exhaust gas passage an expansion space in which the exhaust gas is allowed to expand; a communication pipe coupled to the casing component and having one end that is open to the outside of the expansion space and the other end that is open to the expansion space; a first catalyst located in the exhaust gas passage upstream of the expansion space; and a second catalyst located in the communication pipe in opposition to the expansion space.

In an exhaust device according to the present disclosure, the exhaust gas which has diffused into the expansion space can be passed across the second catalyst back and forth as a function of exhaust gas pulsation. Thus, the number of times of contact between the exhaust gas and the second catalyst can be increased as a result of the pulsation. That is, the exhaust gas which has diffused into the expansion space can produce a backflow which is directed into the second catalyst. Having the diffused exhaust gas circulate back to the second catalyst in this manner can facilitate further contact between the second catalyst and a fraction of the exhaust gas which has not made any contact with the second catalyst. In this way, the amount of the exhaust gas that makes contact with the second catalyst can be increased. Thus, an improved purification performance can be achieved despite a low quantity of catalyst carried.

Any combinations of at least two features disclosed in the claims and/or the specification and/or the drawings should also be construed as encompassed by the present disclosure. Especially, any combinations of two or more of the claims should also be construed as encompassed by the present disclosure.

### BRIEF DESCRIPTION OF THE DRAWINGS

The present disclosure will be more clearly understood from the following description of preferred embodiments made with reference to the accompanying drawings. However, the embodiments and the drawings are given merely for the purpose of illustration and explanation, and should not be used to delimit the scope of the present disclosure, which scope is to be delimited by the appended claims. In the accompanying drawings, alike numerals are assigned to and indicate alike parts throughout the different figures:

FIG. 1 is a side view of one type of a vehicle in the form of a motorcycle with an exhaust device, in accordance with a first embodiment of the present disclosure;

FIG. 2 is a side view of the exhaust device;

FIG. 3 is a plan view of the exhaust device showing the interior of an exhaust chamber;

FIG. 4A is a plan view of the exhaust device illustrating the purification functionality of the exhaust device;

FIG. 4B is another plan view of the exhaust device illustrating the purification functionality of the exhaust device

FIG. 4C is yet another plan view of the exhaust device illustrating the purification functionality of the exhaust device;

FIG. 5 is a plan view of an exhaust device showing the interior of an exhaust chamber, in accordance with a second embodiment of the present disclosure; and

FIG. 6 is a horizontal cross-sectional view of an exhaust device showing the interior of an exhaust chamber, in accordance with a third embodiment of the present disclosure.

### DESCRIPTION OF EMBODIMENTS

What follows is a description of preferred embodiments of the present disclosure made with reference to the drawings. In the following discussions, the terms “front” and “forward(s)” and the terms “rear” and “rearward(s)” refer to sides facing “the front” and “the rear” of a vehicle, respectively, as seen along the direction of travel of the vehicle. Accordingly, a front-to-rear or rear-to-front direction for the vehicle coincides with the longitudinal direction of the vehicle. The terms “left” and “leftward(s)” and the terms “right” and “rightward(s)” refer to sides facing “the left” and “the right” of the vehicle, respectively, as viewed from a driver seated in the vehicle. Accordingly, a left-to-right or right-to-left direction for the vehicle coincides with the widthwise direction of the vehicle.

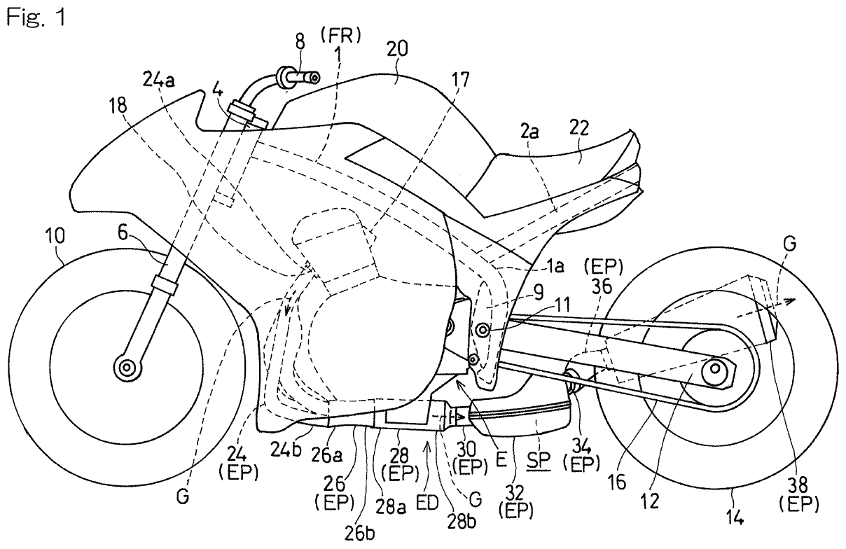

FIG. 1 is a side view of one type of a straddled vehicle in the form of a motorcycle with an exhaust device, in accordance with a first embodiment of the present disclosure. An exhaust device according to the present disclosure can also be applied to vehicles different from motorcycles, such as, for example, three-wheeled vehicles, four-wheeled buggies, utility vehicles, and small planing crafts.

An exhaust device according to the present disclosure has a silencer functionality which reduces the noise of the exhaust gas. In addition, the exhaust device also has a so-called purification functionality with which it can limit the emission of harmful substances contained in the exhaust gas into the atmosphere. The “silencer functionality” in this context involves the attenuation of the pressure energy of the exhaust gas through the provision of a resonant structure and/or the formation of a plurality of compartments that facilitate repeated expansions and contractions of the exhaust gas. Further, the “purification functionality” involves the use of, for example, a platinum group element (i.e., catalyst material), such as platinum (Pt), palladium (Pd), and rhodium (Rh) that are precious noble metals for conversion of harmful substances contained in the exhaust gas into non-harmful substances in a redox reaction between the platinum group element and the exhaust gas. In particular, upon coming into contact with the platinum family element, nitrogen oxides (NOx), carbon monoxides (CO), and hydrocarbons (CH) among the harmful substances contained in the exhaust gas are respectively converted into non-harmful N₂, CO₂, and H₂O.

Referring to FIG. 1, the vehicle body frame structure FR of the motorcycle includes a main frame 1 that makes up the front half of the frame structure FR and a rear frame 2 that makes up the rear half of the frame structure FR. The main frame 1 extends diagonally downwards from a front-end head pipe 4 towards the rear. The main frame 1 is curved downwards at the rear edge 1a thereof and extends substantially vertically downwards therefrom. The rear frame 2 has a front end that is coupled to a portion of the main frame 1 which is located in the vicinity of the rear edge 1a of the main frame 1, and extends from the main frame 1 towards the rear.

A front fork 6 is rotatably supported by the head pipe 4 through a steering shaft (not shown). The front fork 6 has an upper end to which a handle 8 for steering purposes is secured. The front fork 6 has a lower end to which a front wheel 10 is mounted.

A swingarm bracket 9 is provided at a portion of the main frame 1 which is located below the rear edge 1a of the main frame 1. A swingarm 12 is supported on a pivot shaft 11 that is attached to the swingarm bracket 9, so as to freely swing up and down about the pivot shaft 11. The swingarm 12 has a rear end on which a rear wheel 14 is supported.

An engine E which serves as a drive source for the motorcycle is located forwards of and below the main frame 1 and attached to the main frame 1. The engine E drives the rear wheel 14 through power transmission components 16 such as a drive chain. A four-cylinder four-cycle engine E in the instant embodiment is only one of the non-limiting examples of the engine E.

The engine E is formed with intake ports 17 on the rear side thereof and with exhaust ports 18 on the front side thereof. The air introduced via the intake ports 17 is mixed with a fuel to produce an air-fuel mixture which, in turn, is burned in combustion chambers. Exhaust gas G is discharged via the exhaust ports 18. An exhaust device ED for the engine E is attached to the exhaust ports 18. The exhaust device ED will be later discussed in detail.

The main frame 1 supports a fuel tank 20. The fuel tank 20 stores the fuel for the engine E. The fuel tank 20 is located above the engine E. A seat 22 on which the driver can be seated is located rearwards of the fuel tank 20 and is supported on the rear frame 2.

An exhaust device ED according to the present disclosure will be discussed below. The exhaust device ED forms an exhaust gas passage EP through which the exhaust gas G from the engine E is allowed to pass, and purifies the exhaust gas G and discharges the exhaust gas to the external environment. In the following discussions, the terms “upstream” and “downstream” refer to an upstream side and a downstream side, respectively, of the flow of the exhaust gas G as seen along the direction thereof.

The exhaust device ED includes exhaust pipes 24, a collecting pipe 26, a catalyst pipe 28, a chamber inlet pipe 30, an exhaust chamber 32, a chamber outlet pipe 34, a coupling pipe 36, and an exhaust muffler 38.

The exhaust ports 18 connect to the upstream ends 24a of the exhaust pipes 24. Each of the exhaust pipes 24 is associated with a respective one of cylinders. The engine E in the instant embodiment is provided with four exhaust pipes 24. Each of the exhaust pipes 24 extends downwards in front of the engine E, is subsequently curved at a point located below and forwards of the engine E to extend towards the rear, and couples, at the downstream end 24b thereof, to the upstream end 26a of the collecting pipe 26.

Four exhaust gas flow passages EP merge into a single exhaust gas passage EP at the collecting pipe 26. The collecting pipe 26 extends below the engine E towards the rear and has a downstream end 26b that couples to an inlet section 28a of the catalyst pipe 28 represented by the upstream end thereof.

The catalyst pipe 28 is located at a region below the engine E. The exhaust chamber 32 is situated in a zone delimited between the engine E and the rear wheel 14. The exhaust chamber 32 is located below the swingarm 12. The exhaust chamber 32 is configured with a structure that extends across the widthwise center of the vehicle.

The exhaust chamber 32 is formed with a channel having a cross-sectional area that is larger than that of an upstream channel thereof. Thus, the exhaust gas expands and lowers its pressure energy once the exhaust gas is guided into the exhaust chamber 32. Also, a plurality of compartments as well as communication path(s) between different compartments are formed inside the exhaust chamber. This creates a variety of directions of flow from the exhaust gas that has been guided into the exhaust chamber 32 and reduces the pressure energy of the exhaust gas in the process.

The exhaust chamber 32 having such a silencer functionality can help provide the exhaust muffler 38 that is downsized relative to an exhaust muffler that implements a silencer functionality by itself. The exhaust muffler 38 is located on one of the widthwise outer sides of the rear wheel 14.

At the end of a collecting section, the collecting pipe 26 includes a section having a diameter that gradually reduces towards the downstream side thereof. At the end of a point with the smallest diameter, the collecting pipe 26 further includes a section having a diameter that gradually increases towards the downstream side thereof. Since this increasing diameter section connects to the catalyst pipe 28, the flow resistance of the channel drops and makes it easier for the exhaust gas to be guided into the catalyst pipe 28.

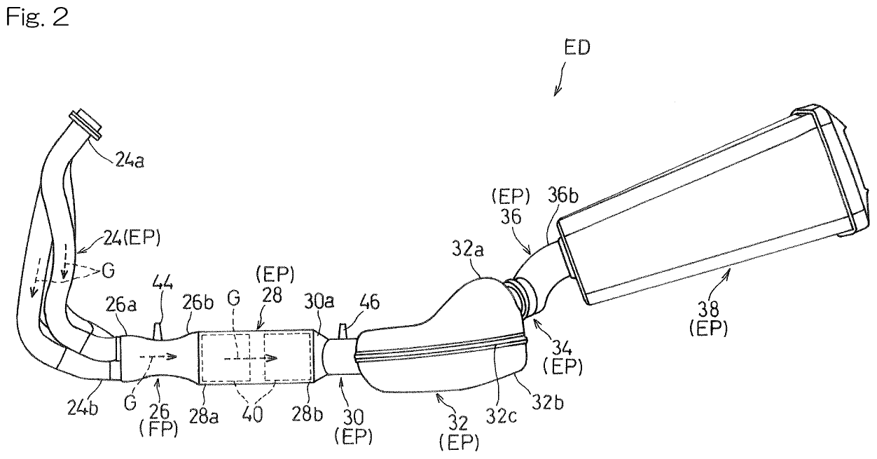

Referring to FIG. 2, a first catalyst 40 is accommodated inside the catalyst pipe 28. The first catalyst 40 is made of the aforementioned catalyst material and converts harmful exhaust gas components contained in the exhaust gas G into non-harmful gas components. The first catalyst 40 is carried on a catalyst support. In the instant embodiment, the first catalyst 40 comprises two catalysts that are spaced apart in the direction of flow of the exhaust gas G. The provision of the two catalysts implies that different flows of the exhaust gas from an upstream one of the catalysts 40 are combined before flowing into a downstream one of the catalysts 40. This makes it easier for different fractions of the exhaust gas to come into contact with the different catalysts 40, thereby facilitating an enhanced purification effect of the catalysts. Nevertheless, this is only one of the non-limiting examples of the number of the first catalysts 40. In the instant embodiment, the upstream and downstream ones of the catalysts forming the first catalysts 40 may be formed identically in shape.

The first catalysts 40 are configured to allow the exhaust gas to be guided therethrough from the upstream side towards the downstream side thereof. For example, the first catalysts 40 are provided with divider walls, a plurality of channels divided thereby, and a catalyst material carried on the divider walls. In particular, the first catalysts 40 may be formed in a honeycomb-like catalyst configuration.

The catalyst pipe 28 (and the first catalysts 40 therein) are formed with a larger cross-sectional area and, in particular, a larger diameter than that of the collecting pipe 26 located upstream thereof. The length of the first catalysts 40 is selected to be longer than that of the collecting pipe 26. The length of the first catalysts 40 herein refers to the combined length of the upstream and downstream ones of the catalysts 40. The collecting pipe 26 is situated in a zone delimited between the front end and rear end of the engine E. The first catalysts 40 are formed to exhibit purification performance (e.g., quantity of catalyst carried and/or volume) that is higher than that exhibited by a second catalyst 42 which will be discussed later. Note that the catalyst pipe 28 may have a cross-sectional area that is smaller than that of the collecting pipe 26 located upstream thereof. Likewise, the length of the catalyst pipe 28 may be shorter than that of the collecting pipe 26.

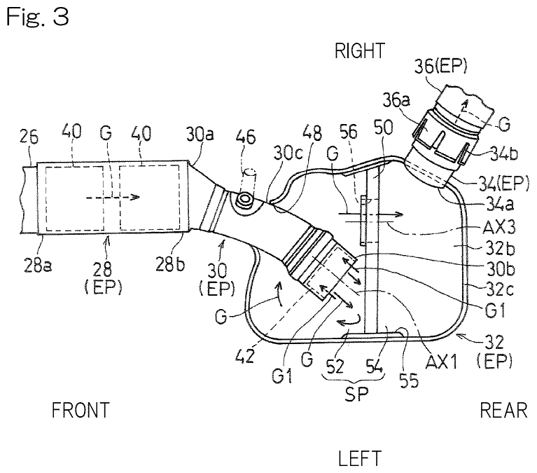

The outlet section 28b of the catalyst pipe 28 represented by the downstream end thereof couples to the upstream end 30a of the chamber inlet pipe 30. As illustrated in FIG. 3, the chamber inlet pipe 30 is joined, at a middle area thereof in the direction of flow of the exhaust gas G, to the exhaust chamber 32. That is, the upstream half and the downstream half of the chamber inlet pipe 30 are respectively positioned outside of the exhaust chamber 32 and inside of the exhaust chamber 32. In other words, the upstream end 30a and the downstream end 30b of the chamber inlet pipe 30 are respectively open to the outside of the exhaust chamber 32 and the inside of the exhaust chamber 32.

In the instant embodiment, the upstream end 30a of the chamber inlet pipe 30 comprises a tapered section having a diameter that gradually decreases towards the downstream side thereof. The tapered section 30a adjoins, at the downstream end thereof, a main body section 30c having a constant pipe diameter. At the downstream end of the main body section 30c, there is an enlargement of a diameter which leads up to the downstream end 30b of the chamber inlet pipe 30. That is, the downstream end 30b of the chamber inlet pipe 30 comprises an enlarged diameter section having a diameter larger than that of the main body section 30c. In other words, the main body section 30c forms a reduced diameter section having a pipe diameter that is smaller than those of the upstream end 30a (or the tapered section) and the downstream end 30b (or the enlarged diameter section). Note, however, that the downstream end 30b of the chamber inlet pipe 30 may have a comparable diameter to that of the main body section 30c. As illustrated in FIG. 3, the downstream end 30b (or the enlarged diameter section) is positioned inside of the exhaust chamber 32. In other words, the main body section 30c of the chamber inlet pipe 30 represents a penetrating section that penetrates through the exhaust chamber 32.

The second catalyst 42 is accommodated in the enlarged diameter section 30b represented by the downstream end of the chamber inlet pipe 30. Just like the first catalysts 40, the second catalyst 42 is also made of the aforementioned catalyst material, and converts and decomposes harmful exhaust gas components contained in the exhaust gas G into non-harmful gas components. The second catalyst 42 is also carried on a catalyst support. The second catalyst 42 may have an identical or different ratio of catalyst materials carried, to/from that of the first catalysts 40. In the instant embodiment, the second catalyst 42 exhibits a quantity of catalyst carried, a volume, and/or a purification capability that is/are lower than that/those exhibited by the first catalysts 40.

According to the present disclosure, the second catalyst 42 is positioned within the exhaust chamber 32. More specifically, the second catalyst 42 is located in opposition to an expansion space SP defined in the exhaust chamber 32. The “expansion space SP” herein refers to a space which is defined within the exhaust gas passage EP and in which the exhaust gas G is allowed to expand. Also, the expression “in opposition to the expansion space SP” encompasses a feature in which the second catalyst 42 and the expansion space SP oppose each other along the direction of flow of the exhaust gas G and a feature in which the second catalyst 42 is situated in the expansion space SP. The expansion space SP is formed to have a flowable cross-sectional area for the gas that is greater than that of the chamber inlet pipe 30. For example, the flowable area defined by the expansion space SP in which the second catalyst 42 is situated is formed to be at least 1.5 times, preferably at least twice, as large as that defined by the chamber inlet pipe 30.

The expansion space SP is also formed to a side of the second catalyst 42 which faces away from the direction of flow. In other words, the exhaust gas is guided into the exhaust chamber 32 through the second catalyst 42 which is positioned a distance apart from the wall surface of the exhaust chamber 32. The incoming exhaust gas is mixed with fractions of the exhaust gas that come from zones of the expansion space SP that are located radially outwards of the second catalyst 42 and/or fractions of the exhaust gas that come from a side of the second catalyst 42 within the expansion space SP which faces away from the direction of flow. Thus, the instant embodiment can provide the effect of improved agitation and mixing of the exhaust gas which has exited the second catalyst 42.

In the instant embodiment, the exhaust chamber 32 forms a casing component in which the expansion space SP is defined and in which the second catalyst 42 is located in opposition to the expansion space SP. Also, in the instant embodiment, the chamber inlet pipe 30 forms a communication pipe coupled to the casing component and having one end which is open to the outside of the expansion space SP and the other end which is open to the expansion space SP and within which the second catalyst 42 is arranged. The other end of the chamber inlet pipe 30 is positioned more proximate to the center of the exhaust chamber 32 than to the inner wall of the exhaust chamber 32. In the instant embodiment, the other end of the chamber inlet pipe 30 is positioned on the front side of the exhaust chamber 32 such that it is more proximate to the center of the chamber than to the inner wall of the exhaust chamber 32. Note that the exhaust chamber 32 and the chamber inlet pipe 30 are respectively only one of the non-limiting examples of the casing component and the communication pipe.

The first catalysts 40 are located upstream of the expansion space SP and the second catalyst 42. A part of the exhaust gas passage EP which is situated between the first catalysts 40 and the second catalyst 42 undergoes reduction of its diameter at the tapered section 30a represented by the upstream end of the chamber inlet pipe 30 and subsequently undergoes enlargement of its diameter at the enlarged diameter section 30b represented by the downstream end of the chamber inlet pipe 30. Accordingly, the reduced diameter section 30c defining a pipe channel with a reduced diameter is defined between the first catalysts 40 and the second catalyst 42.

The second catalyst 42 exhibits purification performance that is lower than that exhibited by the first catalysts 40. That is, the first catalysts 40 serve as primary catalysts while the second catalyst 42 serves as a secondary catalyst. The expression “exhibits purification performance that is lower” herein can encompass at least one of a catalyst support having a shorter length, a catalyst support having a smaller transverse dimension, or the quantity of catalyst carried being smaller. In the instant embodiment, the second catalyst 42 is formed to have a shorter length, a smaller transverse dimension, and a smaller quantity of catalyst carried than the first catalysts 40. When there are more than one first catalyst 40 and/or more than one second catalyst 42, the length of the catalyst support herein corresponds to the sum of the lengths of the respective catalyst supports thereof. In the instant embodiment, the second catalyst 42 exhibits a smaller transverse dimension and a shorter length than the first catalysts 40.

Referring again to FIG. 2, the exhaust device ED in the instant embodiment includes a first exhaust gas sensor 44 and a second exhaust gas sensor 46. The first and second exhaust gas sensors 44 and 46 detect a state of the exhaust gas G flowing through the exhaust gas passage EP. Oxygen sensors that detect the concentration of oxygen in the exhaust gas G are used as the first and second exhaust gas sensors 44 and 46 in the instant embodiment.

The first exhaust gas sensor 44 is located in the exhaust gas passage EP upstream of the first catalysts 40. In the instant embodiment, the first exhaust gas sensor 44 is fitted to the collecting pipe 26. For example, the first exhaust gas sensor 44 is used for air-fuel ratio control of the engine E.

As discussed above, the first exhaust gas sensor 44 is an oxygen sensor, by way of example. The output value of the first exhaust gas sensor 44 can be used for feedback control that facilitates the engine being regulated at such an ideal air-fuel ratio that results in an improved purification performance. The first exhaust gas sensor 44 is arranged at a portion of the collecting pipe 26 which has the most reduced diameter. Since the first sensor 44 is disposed at a point where the exhaust gas is highly densified, the detection result obtained thereby is more likely to represent the average of different flows of the exhaust gas discharged from the different cylinders.

Referring now to FIG. 3, the second exhaust gas sensor 46 is located in the exhaust gas passage EP downstream of the first catalysts 40 and upstream of the second catalyst 42. In the instant embodiment, the second exhaust gas sensor 46 is fitted to the main body section 30c represented by the reduced diameter section of the chamber inlet pipe 30. For example, the second exhaust gas sensor 46 is used to monitor the deterioration level of the first catalysts 40.

As discussed above, the second exhaust gas sensor 46 is an oxygen sensor, by way of example. The output values of the first exhaust gas sensor 44 and the second exhaust gas sensor 46 can be used for feedback control that regulates the engine at an ideal air-fuel ratio which brings about a more improved purification performance than when the first exhaust gas sensor 44 alone is used. Further, the output values of the second exhaust gas sensor 46 and the first exhaust gas sensor 44 can be compared against each other to assess the catalyst efficacy in order to estimate the deterioration status of the first catalysts 40.

The second exhaust gas sensor 46 is arranged at a portion of the inlet pipe 30 which has the most reduced diameter. Since the second sensor 46 is disposed at a point where the exhaust gas is highly densified, the detection result obtained thereby is more likely to represent the average of different flows of the exhaust gas discharged from the first catalysts 40. The second exhaust gas sensor 46 is located upstream of the exhaust chamber 32. In other words, the second exhaust gas sensor 46 is located at a point between the catalyst pipe 28 and the exhaust chamber 32.

The second exhaust gas sensor 46 is arranged in the inlet pipe 30 at a point which is sufficiently far from the exhaust chamber-side open end of the inlet pipe 30. In particular, the former is arranged at a point which is spaced apart from the latter a distance that is at least twice, more preferably at least three times, the length of the second catalyst 42. Thus, a backflow of the exhaust gas from the exhaust chamber 32 can be prevented from reaching the second exhaust gas sensor 46, thereby avoiding possible decrease in its detection precision due to the backflow. Further, the inlet pipe 30 is formed to extend in a curved manner towards the downstream side thereof along the direction of flow. Thus, a backflow of the exhaust gas from the exhaust chamber 32 can be prevented from reaching the second exhaust gas sensor 46, thereby avoiding possible decrease in its detection precision due to the backflow.

Referring back to FIG. 2, the exhaust chamber 32 has a split structure in which a plurality of split bodies are joined to form the exhaust chamber 32. In the instant embodiment, the exhaust chamber 32 comprises two split bodies consisting of first and second split bodies 32a and 32b that are welded at joining sections 32c thereof. More specifically, the exhaust chamber 32 has a split structure of upper and lower two split bodies consisting of the upper, first split body 32a and the lower, second split body 32b that are joined at the joining sections 32c thereof,

FIG. 3 is a plan view depicting a state without the first split body 32a. The exhaust chamber 32 is generally rectangular when viewed in a plan view, and the joining sections 32c are provided along the entire circumference of its outer contour. The first split body 32a and the second split body 32b are externally welded along the entire circumference thereof with the joining sections 32c of the two being vertically mated to each other.

The chamber inlet pipe 30 in which the second catalyst 42 is located is joined to the first and second split bodies 32a and 32b with the chamber inlet pipe 30 being fittedly coupled to the joining sections 32c of the latter two. More specifically, the joining section 32c of the first split body 32a and the joining section 32c of the second split body 32b are formed with semi-circular insertion areas 48 and 48. A lower half body of the chamber inlet pipe 30 is fittedly coupled to the semi-circular insertion area 48 of the lower, second split body 32b, while an upper half body of the chamber inlet pipe 30 is fittedly coupled to the semi-circular insertion area 48 of the upper, first split body 32a. Welding is done between the chamber inlet pipe 30 in this state and the first and second split bodies 32a and 32b.

The chamber inlet pipe 30 is joined to the first and second split bodies 32a and 32b at the main body section 30c having a reduced diameter. By joining the chamber inlet pipe 30 to the first and second split bodies 32a and 32b while being fittedly coupled to the joining sections 32c of the latter two, even the enlarged diameter section 30b having an enlarged diameter can be positioned inside of the exhaust chamber 32 when connecting the chamber inlet pipe 30 to the exhaust chamber 32.

The chamber outlet pipe 34 is coupled to the upper, first split body 32a. More specifically, the first split body 32a is formed with a pipe insertion hole 32aa. The chamber outlet pipe 34 is welded to the first split body 32a while being inserted into the pipe insertion hole 32aa of the first split body 32a.

The exhaust chamber 32 includes a divider wall 50 in the interior thereof. The divider wall 50 is arranged inside the exhaust chamber 32 and separates the expansion space SP into a plurality of expansion compartments 52 and 54. In the instant embodiment, a single divider wall 50 separates the expansion space SP into an upstream, first expansion compartment 52 and a downstream, second expansion compartment 54. Note that these are only some of the non-limiting examples of the numbers of the divider wall 50 and the expansion compartments 52 and 54. The divider wall 50 is welded to the inner wall of the exhaust chamber 32. A rib 55 may be provided for reinforcement purposes at a site of the inner wall of the exhaust chamber 32 to which the divider wall 50 is welded.

The divider wall 50 is formed with a communication hole 56. The communication hole 56 penetrates through the divider wall 50 to communicate the first expansion compartment 52 and the second expansion compartment 54 with each other. A single communication hole 56 provided in the instant embodiment is only one of the non-limiting examples of the number of the communication hole 56.

The downstream end 30b of the chamber inlet pipe 30 is open to the first expansion compartment 52. That is, the second catalyst 42 is positioned in the first expansion compartment 52 and is in fluid communication with the first expansion compartment 52. In the instant embodiment, the downstream end 30b of the chamber inlet pipe 30 defines an axis AX1 slanting relative to the divider wall 50. Further, the chamber inlet pipe 30 is open towards a portion of the divider wall 50 which is spaced apart from the communication hole 56. In the illustrated example, the right side of the divider wall 50 is formed with the communication hole 56, while the chamber inlet pipe 50 is open towards the left side of the divider wall 50.

The axis AX1 of the downstream end 30b of the chamber inlet pipe 30 is not aligned with the axis AX3 of the communication hole 56. In particular, the axis AX1 of the downstream end 30b of the chamber inlet pipe 30 and the axis AX3 of the communication hole 56 diverge when viewed in a cross section with respect to the direction of flow. Further, the axis AX1 of the downstream end 30b of the chamber inlet pipe 30 and the axis AX3 of the communication hole 56 are not parallel.

The upstream end 34a of the chamber outlet pipe 34 is inserted into the exhaust chamber 32 such that it is open to the second expansion compartment 54. The downstream end 34b of the chamber outlet pipe 34 couples to the upstream end 36a of the coupling pipe 36.

Still referring to FIG. 2, the coupling pipe 36 extends in the widthwise direction (towards the right), is subsequently curved, and extends towards the rear such that the downstream end 36b of the coupling pipe 36 couples to the exhaust muffler 38. As shown in FIG. 1, the exhaust muffler 38 is located on the right side of the rear wheel 14. After having its noise reduced by the exhaust muffler 38, the exhaust gas G is discharged out to the external environment.

The flow of the exhaust gas G in the exhaust device ED of the instant embodiment is explained. Upon initiating the operation of the engine E, the exhaust gas G is delivered out to the exhaust pipes 24 via the exhaust ports 18. The exhaust gas G exiting the four exhaust pipes 24 shown in FIG. 2 meets at the collecting pipe 26. The combined flow of the exhaust gas G at the collecting pipe 26 is delivered to the catalyst pipe 28. In this process, the first exhaust gas sensor 44 detects the concentration of oxygen in the exhaust gas G.

Upon entering the catalyst pipe 28, the exhaust gas G travels through the first catalysts 40 for purification. The exhaust gas G exiting the catalyst pipe 28 flows into the chamber inlet pipe 30. Upon entering the chamber inlet pipe 30 shown in FIG. 3, the exhaust gas G passes through the main body section 30c of the chamber inlet pipe 30 and subsequently travels through the second catalyst 42 at the downstream end 30b of the same for purification. When the exhaust gas passes through the main body section 30c, the second exhaust gas sensor 46 detects the concentration of oxygen in the exhaust gas.

After being purified by the second catalyst 42, the exhaust gas G flows out into and expands in the first expansion compartment 52 of the exhaust chamber 32. Upon being flown out into the first expansion compartment 52, the exhaust gas G collides with and gets diffused by the divider wall 50. Further, a fraction G1 of the exhaust gas G which has diffused into the first expansion compartment 52 is directed back into the second catalyst 42 by exhaust gas pulsation for purification.

The exhaust gas G inside the first expansion compartment 52 flows through the communication hole 56 into and expands in the second expansion compartment 54. Through repeated expansions and contractions on the way, the noise of the exhaust gas G is reduced. The exhaust gas G inside the second expansion compartment 54 is discharged from the exhaust chamber 32 by passing through the chamber outlet pipe 34.

After being discharged from the exhaust chamber 32, the exhaust gas G flows through the coupling pipe 36 and into the exhaust muffler 38. After flowing into and having its noise reduced by the exhaust muffler 38, the exhaust gas G is discharged out to the atmosphere.

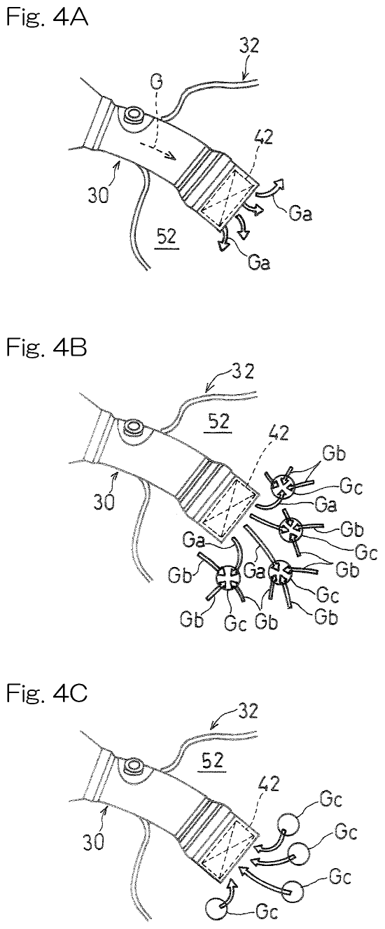

The exhaust gas purification functionality of the exhaust device ED of the instant embodiment will be explained below, with the aid of FIGS. 4A to 4C. As illustrated in FIG. 4A, the exhaust gas Ga purified by the second catalyst 42 flows out into, and expands and spreads in the first expansion compartment 52 of the exhaust chamber 32.

As illustrated in FIG. 4B, the exhaust gas Ga, which has flown out of the chamber inlet pipe 30 and diffused into the first expansion compartment 52, is mixed with the exhaust gas Gb already inside the first expansion compartment 52. In the following discussions, the mixture of the exhaust gas Ga and the exhaust gas Gb will be referred to as “mixed exhaust gas Gc.”

As illustrated in FIG. 4C, a backflow of the mixed exhaust gas Gc is generated and directed back into the second catalyst 42 for purification by exhaust gas pulsation. In this way, the exhaust gas (or the mixed exhaust gas Gc) different from the previously passed exhaust gas G is re-purified by the second catalyst 42, thereby achieving an improved purification performance relative to that achieved by identical exhaust gas (or the exhaust gas Ga previously purified by the second catalyst 42) being re-purified. The mixed exhaust gas Gc purified by the second catalyst 42 is flown out into, and expands and spreads in the first expansion compartment 52 of the exhaust chamber 32. Similar actions will then take place repeatedly.

According to the above-described configuration, the exhaust gas G and G1 which has diffused into the expansion space SP can be passed across the second catalyst 42 back and forth as a function of exhaust gas pulsation, as shown in FIG. 3. Thus, the number of times of contact between the exhaust gas G and the second catalyst 42 can be increased as a result of the pulsation. That is, the exhaust gas G which has diffused into the expansion space SP can be directed into and out of the second catalyst 42, thereby increasing the fraction of the exhaust gas G and G1 that makes contact with the second catalyst 42. Thus, an improved purification performance can be achieved despite a low quantity of catalyst carried.

In the instant embodiment, the second catalyst 42 is arranged at the downstream end 30b of the chamber inlet pipe 30, and the expansion space SP adjoining the chamber inlet pipe 30 has a dimension that is perpendicular to the direction of flow of the exhaust gas, i.e., the front-to-rear direction, and greater than the diameter of the downstream end 30b of the chamber inlet pipe 30. That is, the expansion space SP adjoining the chamber inlet pipe 30 is greater in size than the chamber inlet pipe 30. Hence, an abrupt change in pressure of the exhaust gas G can be achieved at the transition between the chamber inlet pipe 30 and the expansion space SP. As a result, the flow of the exhaust gas G becomes turbulent, thereby inducing the diffused exhaust gas G in the expansion space SP to be directed into and out of the second catalyst 42. Thus, the fraction of the exhaust gas G that makes contact with the second catalyst 42 can be increased, thereby achieving an improved purification performance despite a low quantity of catalyst carried.

In the instant embodiment, the second catalyst 42 exhibits purification performance that is lower than that exhibited by the first catalysts 41. According to this configuration, excess in the performance of the catalysts as a whole can be avoided by selecting catalysts exhibiting a higher purification performance as the first catalysts 40 which serve as the primary catalysts and selecting a catalyst exhibiting a lower purification performance as the second catalyst 42 which serves as the secondary catalyst.

In the instant embodiment, the divider wall 50 is arranged inside the exhaust chamber 32 and separates the expansion space SP into the plurality of expansion compartments 52 and 54, and the downstream end 30b of the chamber inlet pipe 30 defines an axis AX1 slanting relative to the divider wall 50. According to this configuration, the exhaust gas G discharged from the chamber inlet pipe 30 hits and gets diffused by the divider wall 50. As a result, the flow of the exhaust gas G becomes turbulent, thereby inducing the diffused exhaust gas G in the expansion space SP to be directed into and out of the second catalyst 42. Thus, the fraction of the exhaust gas G that makes contact with the second catalyst 42 can be increased, thereby achieving an improved purification performance despite a low quantity of catalyst carried.

In the instant embodiment, the divider wall 50 is formed with the communication hole 56 through which the first expansion compartment 52 and the second expansion compartment 54 communicate with each other, and the chamber inlet pipe 30 is open towards a portion of the divider wall 50 which is spaced apart from the communication hole 56. According to this configuration, the exhaust gas G discharged from the chamber inlet pipe 30 hits and gets diffused by the divider wall 50 instead of moving towards the communication hole 56. As a result, the flow of the exhaust gas G becomes turbulent, thereby inducing the diffused exhaust gas G in the expansion space SP to be directed into and out of the second catalyst 42. Thus, the fraction of the exhaust gas G that makes contact with the second catalyst 42 can be increased, thereby achieving an improved purification performance despite a low quantity of catalyst carried.

In the instant embodiment, the second catalyst 42 is arranged at the downstream end 30b of the chamber inlet pipe 30, the second catalyst 42 has a transverse dimension smaller than that of the first catalysts 40, and the chamber inlet pipe 30 has the reduced diameter section 30c defined between the first catalysts 40 and the second catalyst 42 and defining a pipe channel with a reduced diameter. According to this configuration, the controlled flows of the exhaust gas G from the first catalysts 40 are agitated when exiting the reduced diameter section 30c before flowing into the second catalyst 42. This can help the exhaust gas G make contact with the entirety of the second catalyst 42, thereby augmenting the purification performance.

In the instant embodiment, the exhaust chamber 32 has a split structure in which the plurality of split bodies 32a and 32b are joined to form the exhaust chamber 32, and the chamber inlet pipe 30 is fittedly coupled to the joining sections 32c of the split bodies 32a and 32b. According to this configuration, the split bodies 32a and 32b can be joined to each other while the chamber inlet pipe 30 in which the second catalyst 42 is located is being fittedly coupled thereto, to assemble the exhaust chamber 32. In this way, the chamber inlet pipe 30 can be assembled with the exhaust chamber 32 despite the fact that the downstream end 30b at which the second catalyst 42 is arranged constitutes the enlarged diameter section.

As illustrated in FIG. 2, in the instant embodiment, the first exhaust gas sensor 44 is located upstream of the first catalysts 40, and the second exhaust gas sensor 46 is located downstream of the first catalysts 40 and upstream of the second catalyst 42, in the exhaust gas passage EP. According to this configuration, the two exhaust gas sensors 44 and 46 can be used to ascertain the deterioration level of the first catalysts 40. Further, the second catalyst 42 can be positioned without paying much attention to the locations of the sensors 44 and 46 because the influence of the second catalyst 42 can be ignored during the deterioration determination, thereby resulting in an enhanced freedom of design.

Further embodiments will be discussed below. In the discussions of the embodiments, features analogous to those in the preceding embodiment will be numbered similarly and will not be described in detail.

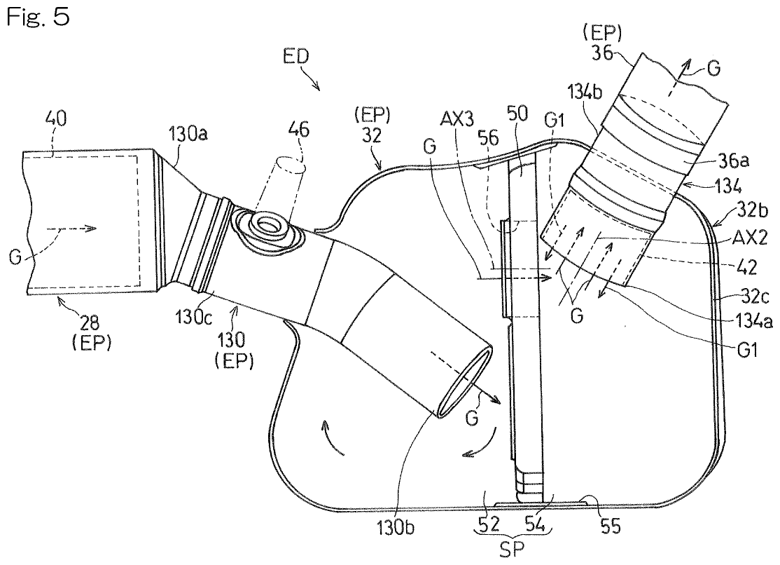

FIG. 5 illustrates relevant features of an exhaust device ED in accordance with a second embodiment of the present disclosure. While the second catalyst 42 is arranged at the downstream end 30b of the chamber inlet pipe 30 in the preceding first embodiment, the second catalyst 42 in the second embodiment is arranged not in the chamber inlet pipe 130 but at the upstream end 134a of the chamber outlet pipe 134. That is, in the second embodiment, the chamber outlet pipe 134 constitutes a communication pipe coupled to the casing component and having one end which is open to the outside of the expansion space SP and the other end which is open to the expansion space SP and at which the second catalyst 42 is arranged. The features of the second embodiment are otherwise identical to the first embodiment.

As illustrated in FIG. 5, in the second embodiment, the downstream end 130b of the chamber inlet pipe 130 does not constitute the enlarged diameter section but has a comparable diameter to that of the main body section 130c, given that the second catalyst 42 is not located in the chamber inlet pipe 130. It should be recognized that the design of the upstream end 130a, i.e., the tapered section 130a, of the chamber inlet pipe 130 is identical to that of the tapered section 30a in the first embodiment.

As discussed above, in the second embodiment, the second catalyst 42 is arranged at the upstream end 134a of the chamber outlet pipe 134 and located in opposition to the expansion space SP within the exhaust chamber 32. Further, the chamber outlet pipe 134 defines an axis AX2 slanting relative to the divider wall 50. The chamber outlet pipe 134 penetrates through the exhaust chamber 32 and has a downstream end 134b that couples to the upstream end 36a of the coupling pipe 36.

The axis AX2 of the chamber outlet pipe 134 is not aligned with the axis AX3 of the communication hole 56. In particular, the axis AX2 of the chamber outlet pipe 134 and the axis AX3 of the communication hole 56 diverge when viewed in a cross section with respect to the direction of flow. Further, the axis AX2 of the chamber outlet pipe 134 and the axis AX3 of the communication hole 56 are not parallel.

The flow of the exhaust gas G in the exhaust device ED of the second embodiment is explained. Its flow prior to being discharged from the catalyst pipe 28 is identical to that in the first embodiment. The exhaust gas G exiting the catalyst pipe 28 flows into the chamber inlet pipe 130. Upon entering the chamber inlet pipe 130, the exhaust gas G passes through the main body section 30c of the chamber inlet pipe 30, and subsequently flows out of the downstream end 30b into and expands in the first expansion compartment 52 of the exhaust chamber 32. When the exhaust gas passes through the main body section 30c, the second exhaust gas sensor 46 detects the concentration of oxygen in the exhaust gas.

Upon being flown out into the first expansion compartment 52, the exhaust gas G collides with and gets diffused by the divider wall 50. The exhaust gas G inside the first expansion compartment 52 flows through the communication hole 56 into and expands in the second expansion compartment 54. Through repeated expansions and contractions on the way, the noise of the exhaust gas G is reduced.

The exhaust gas G inside the second expansion compartment 54 enters the upstream end 134a of the chamber outlet pipe 134. Upon entering the upstream end 134a of the chamber outlet pipe 134, the exhaust gas G travels through the second catalyst 42 for purification. Further, a fraction G1 of the exhaust gas G which has travelled through the second catalyst 42 is returned to the second expansion compartment 54 by exhaust gas pulsation. After moving past the second catalyst 42, the exhaust gas G is discharged from the exhaust chamber 32 by passing through the chamber outlet pipe 134. Its flow after being discharged from the exhaust chamber 32 is identical to that in the first embodiment.

According to the second embodiment, the exhaust gas G and G1 in the expansion space SP can be passed across the second catalyst 42 back and forth as a function of exhaust gas pulsation, as in the first embodiment. Thus, the number of times of contact between the exhaust gas G and the second catalyst 42 can be increased as a result of the exhaust gas pulsation. That is, the exhaust gas G which has diffused into the expansion space SP can be directed into and out of the second catalyst 42, thereby increasing the fraction of the exhaust gas G and G1 that makes contact with the second catalyst 42. Thus, an improved purification performance can be achieved despite a low quantity of catalyst carried.

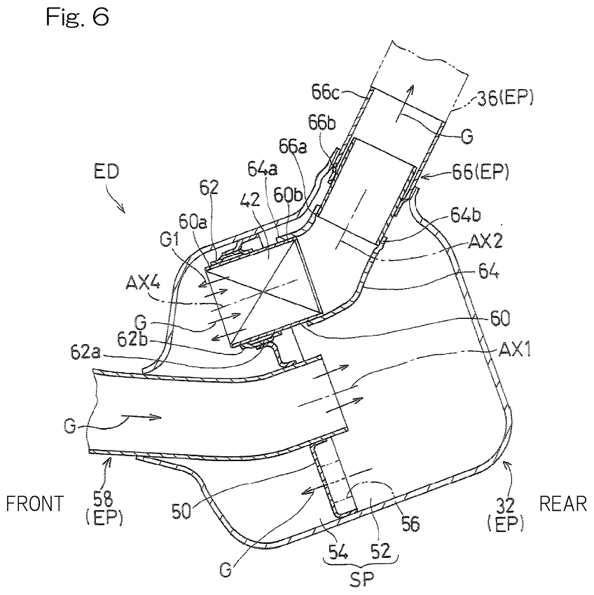

FIG. 6 illustrates relevant features of an exhaust device ED in accordance with a third embodiment of the present disclosure. In the third embodiment, a chamber inlet pipe 58 extends into the interior volume of the exhaust chamber 32 towards the rear, penetrates through the divider wall 50, and is open to the expansion space SP inside the exhaust chamber 32. That is, in the third embodiment, the first expansion compartment 52 is defined on the rear side of the divider wall 50, while the second expansion compartment 54 is defined on the front side of the divider wall 50. The divider wall 50 is formed with the communication hole 56 through which the first expansion compartment 52 and the second expansion compartment 54 communicate with each other.

An auxiliary catalyst pipe 60 in which the second catalyst 42 is received is positioned through the divider wall 50. That is, the upstream end 60a and the downstream end 60b of the auxiliary catalyst pipe 60 are respectively positioned in the second expansion compartment 54 and in the first expansion compartment 52, along the direction of flow of the exhaust gas G. The upstream end 60a of the auxiliary catalyst pipe 60 is open to the second expansion compartment 54.

The upstream end 60a of the auxiliary catalyst pipe 60 is welded to the divider wall 50. More specifically, the upstream end 60a of the auxiliary catalyst pipe 60 is supported through a first rib 62 on the divider wall 50 in a displaceable manner relative thereto. The first rib 62 is formed of a bent metal sheet having a U-shaped cross section with a U-shaped bottom 60a joined to the divider wall 50 and legs 60b and 60b joined to the auxiliary catalyst pipe 60. Being made of the metal sheet, the first rib 62 can elastically deform to absorb the difference in thermal expansion between the auxiliary catalyst pipe 60 and the divider wall 50.

The downstream end 60b of the auxiliary catalyst pipe 60 is coupled through a connecting pipe 64 to the upstream end 66a of the chamber outlet pipe 66. More specifically, the upstream end 64a of the connecting pipe 64 is welded to the downstream end 60b of the auxiliary catalyst pipe 60, and the downstream end 64b of the connecting pipe 64 is welded to the upstream end 66a of the chamber outlet pipe 66. The chamber outlet pipe 66 in the instant embodiment comprises a straight pipe having an intermediate section 66b that is supported on the exhaust chamber 32 and a downstream end 66c that couples, on the outside of the expansion space SP, to the coupling pipe 36.

Thus, the auxiliary catalyst pipe 60 in which the second catalyst 42 is received is supported at the upstream end 60a by the divider wall 50 and is supported at the downstream end 60b by the exhaust chamber 32 through the connecting pipe 64 and the chamber outlet pipe 66. That is, the auxiliary catalyst pipe 60 is supported by the exhaust chamber 32 at both ends 60a and 60b thereof.

In the third embodiment, the auxiliary catalyst pipe 60, the connecting pipe 64, and the chamber outlet pipe 66 cooperate together to constitute a communication pipe coupled to the casing component (or exhaust chamber 32) and having one end (or downstream end) which is open to the outside of the expansion space SP and the other end (or upstream end) which is open to the expansion space SP and at which the second catalyst 42 is arranged.

In the instant embodiment, the auxiliary catalyst pipe 60 is positioned to define an axis AX4 which is angled relative to the axis AX2 of the chamber outlet pipe 66. Therefore, in the instant embodiment, the connecting pipe 64 is formed by a curved pipe. This gives the auxiliary catalyst pipe 60 an enhanced freedom of positioning which, in turn, makes it easier for a space for the second catalyst 42 to be secured. The features of the third embodiment are otherwise identical to the first and second embodiments.

According to the third embodiment, the exhaust gas G and G1 in the expansion space SP can be passed across the second catalyst 42 back and forth as a function of exhaust gas pulsation, as in the first and second embodiments. Thus, the number of times of contact between the exhaust gas G and the second catalyst 42 can be increased as a result of the exhaust gas pulsation. That is, the exhaust gas G which has diffused into the expansion space SP can be directed into and out of the second catalyst 42, thereby increasing the fraction of the exhaust gas G and G1 that makes contact with the second catalyst 42. Thus, an improved purification performance can be achieved despite a low quantity of catalyst carried.

Oxygen sensors used in the above-described embodiments to detect the concentration of oxygen in the exhaust gas are only one of the non-limiting examples of the exhaust gas sensors 44 and 46. Other examples can include temperature sensors that detect the temperature of the exhaust gas.

An exhaust device according to the present disclosure is also applicable to engines with more than or less than four cylinders, including single-cylinder engines. Further, as an alternative to the catalysts 40 located downstream of the collecting pipe 26 in the above-described embodiments, a catalyst may be provided for each of cylinders on a multi-cylinder engine. In this case, the collecting pipe 26 may be omitted.

The embodiments merely represent some of the non-limiting examples of the locations of the exhaust chamber 32 and the exhaust muffler 38. For example, the exhaust muffler 38 may be located on each of the widthwise sides of the rear wheel 38 or above the rear wheel. Further, the exhaust chamber 32 can have any geometry as long as it provides the expansion space, with the above-described embodiments merely representing some of the non-limiting examples of the geometry of the exhaust muffler 32.

Also, a variety of materials can be used as a material of the catalysts, with the above-described embodiments merely representing some of the non-limiting examples of the material of the catalysts. Thus, materials different from the above-described platinum group metals can be used as a material of the catalysts. Further, a variety of fuels different from gasoline can be used as the fuel for the engine E. Ethanol may be included, or hydrogen may be used.

A relatively small saddle-riding vehicle with a seat on which a driver can be seated in a straddled position is only one of the non-limiting examples of the vehicle to which an exhaust device according to the present disclosure can be installed. For instance, a four-wheeled vehicle in which passengers can be seated side-by side in the widthwise direction may be employed as the vehicle. Also, an exhaust device according to the present disclosure may be employed on a hybrid vehicle with an internal combustion engine and an electric motor.

The above-described implementations represent only some of the non-limiting examples of the present disclosure. Various additions, modifications, and omissions can be made therein without departing from the principle of the present disclosure and, thus, are also encompassed within the scope of the present disclosure, by way of example.

What is claimed is:

1. An exhaust device that forms an exhaust gas passage through which exhaust gas from an engine is allowed to pass, and that purifies the exhaust gas and discharges the exhaust gas to an external environment, the exhaust device comprising:
a casing component defining within the exhaust gas passage an expansion space in which the exhaust gas is allowed to expand;
a communication pipe coupled to the casing component and having one end that is open to an outside of the expansion space and the other end that is open to the expansion space;
a first catalyst located in the exhaust gas passage upstream of the expansion space; and
a second catalyst located in the communication pipe in opposition to the expansion space.

2. The exhaust device as claimed in claim 1, wherein the second catalyst is arranged at the other end of the communication pipe, and the expansion space adjoining the communication pipe has a dimension that is perpendicular to a direction of flow of the exhaust gas and greater than a diameter of the other end of the communication pipe.

3. The exhaust device as claimed in claim 1, wherein the second catalyst exhibits purification performance that is lower than that exhibited by the first catalyst.

4. The exhaust device as claimed in claim 1, further comprising:
a divider wall arranged inside the casing component and separating the expansion space into a plurality of expansion compartments, wherein the communication pipe defines an axis slanting relative to the divider wall.

5. The exhaust device as claimed in claim 1, further comprising:
a divider wall arranged inside the casing component and separating the expansion space into a plurality of expansion compartments, wherein
the divider wall is formed with a communication hole through which adjacent ones of the expansion compartments communicate with each other, and
the communication pipe is open towards a portion of the divider wall which is spaced apart from the communication hole.

6. The exhaust device as claimed in claim 1, wherein
the communication pipe comprises an inlet pipe having a downstream end that is open to the expansion space,
the second catalyst is arranged at the downstream end of the inlet pipe,
the second catalyst has a transverse dimension smaller than that of the first catalyst, and
the inlet pipe has a reduced diameter section defined between the first catalyst and the second catalyst and defining a pipe channel with a reduced diameter.

7. The exhaust device as claimed in claim 1, wherein
the casing component has a split structure in which a plurality of split bodies are joined to form the casing component, and
the pipe in which the second catalyst is located is fittedly coupled to joining sections of the split bodies.

8. The exhaust device as claimed in claim 1, further comprising:
a first exhaust gas sensor located in the exhaust gas passage upstream of the first catalyst to detect a state of the exhaust gas flowing through the exhaust gas passage; and
a second exhaust gas sensor located in the exhaust gas passage downstream of the first catalyst and upstream of the second catalyst to detect a state of the exhaust gas flowing through the exhaust gas passage.

9. A vehicle comprising the exhaust device as claimed in claim 1.
